(19) United States
(12) Patent Application Publication
(10) Pub. No.: US 2026/0222488 A1
(43) Pub. Date: Jul. 30, 2026

(54) PROVIDING CALLER IDENTIFICATION FEEDBACK VIA A CALL SIGNALING SESSION

(71) Applicant: Microsoft Technology Licensing, LLC, Redmond, WA (US)

(72) Inventor: Stanley Ohumegbulem OSAJEH, Tallinn (EE)

(73) Assignee: Microsoft Technology Licensing, LLC, Redmond, WA (US)

(21) Appl. No.: 19/037,476

(22) Filed: Jan. 27, 2025

(51) Int. Cl. H04M 3/42

(52) U.S. Cl. CPC H04M 3/42042

(57) ABSTRACT

A data processing system implements extracting a second caller ID for presentation on a callee device from routing information component of a call notification message received during a call signaling session; assigning the extracted second caller ID as a value to a caller identification parameter, the value being used to compare against a first caller ID associated with the caller device to determine whether there is a mismatch; generating a feedback integrity value including the extracted second caller ID and a random string and assigning the feedback integrity value to a feedback integrity parameter, the feedback integrity value being tracked to determine a change to the value of the caller identification parameter made on a call path; generating a response to the call notification message that includes the caller identification parameter, the feedback integrity parameter, and their values; and forwarding the response to the caller device.

### BACKGROUND

Communication service providers (e.g., wireless, cellular, etc.) are continually challenged to deliver value and convenience to consumers by, for example, providing compelling network services. One area of interest has been in securing caller identification (ID) that allows a user to identify who is calling before answering, thereby reducing the risk of falling victim to scams or unwanted telemarketing calls. In some countries, communication service providers are required by law to provide accurate caller IDs and to prevent fraudulent calling practices. However, there is no efficient and reliable way for communication service providers to verify the caller ID presented on a callee device at scale. Currently, communication service providers rely on users to report caller ID issues, such as outdated caller IDs, spoofing, and the like, then investigate the causes of the issues. This is particularly cumbersome for the communication service providers handling high volumes of calls, where troubleshooting and detecting caller ID issues is at scale. Hence, there is a need for improved systems and methods for handling caller ID issues automatically, efficiently and at scale.

### SUMMARY

An example data processing system for detecting a mismatch between a first caller identification (“ID”) associated with a caller device and a second caller ID for presentation on a callee device during a call signaling session for a call including the caller device and the callee device, includes a processor and a machine-readable medium storing executable instructions. The instructions when executed cause the processor alone or in combination with other processors to perform operations including receiving during the call signaling session a call notification message over a communication network, the call notification message notifying the callee device about an incoming call from the caller device or notifying the caller device of a response of the callee device to the incoming call, the call notification message including a routing information component identifying the second caller ID for presentation on the callee device and a callee ID associated with the callee device; extracting the second caller ID from the routing information component and assigning the extracted second caller ID as a value to a caller identification parameter, the value being used to compare against the first caller ID associated with the caller device to determine whether there is the mismatch; generating a feedback integrity value including the extracted second caller ID and a random string and assigning the feedback integrity value to a feedback integrity parameter, the feedback integrity value being tracked to determine a change to the value of the caller identification parameter made on a call path from the callee device to the caller device; generating a response to the call notification message that includes the caller identification parameter, the feedback integrity parameter, and their respective parameter values; and forwarding the response to the caller device.

An example method for detecting a mismatch between a first caller identification (“ID”) associated with a caller device and a second caller ID for presentation on a callee device during a call signaling session for a call including the caller device and the callee device, as implemented in a data processing system, includes receiving during the call signaling session a call notification message over a communication network, the call notification message notifying the callee device about an incoming call from the caller device or notifying the caller device of a response of the callee device to the incoming call, the call notification message including a routing information component identifying the second caller ID for presentation on the callee device and a callee ID associated with the callee device; extracting the second caller ID from the routing information component and assigning the extracted second caller ID as a value to a caller identification parameter, the value being used to compare against the first caller ID associated with the caller device to determine whether there is the mismatch; generating a feedback integrity value including the extracted second caller ID and a random string and assigning the feedback integrity value to a feedback integrity parameter, the feedback integrity value being tracked to determine a change to the value of the caller identification parameter made on a call path from the callee device to the caller device; generating a response to the call notification message that includes the caller identification parameter, the feedback integrity parameter, and their respective parameter values; and forwarding the response to the caller device.

An example non-transitory computer readable medium for detecting a mismatch between a first caller identification (“ID”) associated with a caller device and a second caller ID for presentation on a callee device during a call signaling session for a call including the caller device and the callee device, on which are stored instructions that, when executed, cause a programmable device to perform functions of receiving during the call signaling session a call notification message over a communication network, the call notification message notifying the callee device about an incoming call from the caller device or notifying the caller device of a response of the callee device to the incoming call, the call notification message including a routing information component identifying the second caller ID for presentation on the callee device and a callee ID associated with the callee device; extracting the second caller ID from the routing information component and assigning the extracted second caller ID as a value to a caller identification parameter, the value being used to compare against the first caller ID associated with the caller device to determine whether there is the mismatch; generating a feedback integrity value including the extracted second caller ID and a random string and assigning the feedback integrity value to a feedback integrity parameter, the feedback integrity value being tracked to determine a change to the value of the caller identification parameter made on a call path from the callee device to the caller device; generating a response to the call notification message that includes the caller identification parameter, the feedback integrity parameter, and their respective parameter values; and forwarding the response to the caller device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a block diagram of an example communication services system in which the techniques for providing caller ID feedback via a call signaling session are implemented.

FIG. 2 is a sequence diagram of a voice over Voice over Internet Protocol (VoIP) signaling session of the system of FIG. 1.

FIG. 3 are example call notification messages during a VoIP signaling session that implement the techniques described herein.

FIG. 4 is a flow chart of an example process for providing caller ID feedback via a call signaling session according to the techniques disclosed herein.

FIG. 5 is a block diagram showing an example software architecture, various portions of which may be used in conjunction with various hardware architectures herein described, which may implement any of the described features.

FIG. 6 is a block diagram showing components of an example machine configured to read instructions from a machine-readable medium and perform any of the features described herein.

### DETAILED DESCRIPTION

Communication service providers employ different strategies to identify and mitigate caller ID mismatches, which are often indicative of caller ID spoofing-a tactic used in fraudulent activities. For example, the STIR/SHAKEN Framework is implemented to authenticate and verify caller ID information for VoIP networks. The Framework uses digital certificates based on public key cryptography to ensure the calling number is secure. Service providers digitally sign calls originated by customers, enabling the called party to verify that the calling number is accurate and has not been spoofed. However, this strategy does not track the caller ID presented on a callee device.

As another example, advanced analytics and artificial intelligence (AI) are utilized to monitor call patterns and to detect anomalies that may indicate caller ID spoofing. By analyzing call metadata, such as frequency, duration, and destination, providers can identify suspicious activities and potential mismatches between the displayed caller ID and the actual originating number. This strategy also fails to track the caller ID presented on a callee device.

Another strategy is to capture a caller device screen when an incoming call rings (e.g., caller ID), to apply optical character recognition (OCR) on the captured image to get text of the caller ID as displayed on the screen, and to send the caller ID text to a validation database for checking the caller ID's accuracy. Although this strategy tracks the caller ID presented on a callee device, it takes extra hardware and software resources to capture images and perform OCR. In addition, it requires a channel separated from the call signaling session to transmit the caller ID text to a third party (e.g., a validation database) to validate the caller ID.

To address these technical problems, the present application describes a technical solution of a call notification message free-riding strategy that inserts a caller ID as presented on a callee device into a call notification message during a call signaling session, such as a Session Initiation Protocol (SIP) session. As such, no extra hardware and software resources are required outside of SIP, and the presented caller ID is sent back to the caller device or the caller carrier proxy via a SIP call notification response (without using a separated channel).

SIP is a widely used signaling protocol for initiating, maintaining, and terminating real-time communication sessions. SIP supports various communication services, including voice, video, and messaging. Caller Line Identification (CLI) is a feature that transmits the caller's phone number to the callee's device, providing essential information for call screening and management. Currently, the SIP provides mechanisms, such as FROM, P-Asserted-Identity (PAI), and Identity (in STIR/SHAKEN) headers for delivering CLIs to the callee's device, but not back to the calling entity. The call notification message free-riding strategy utilizes a SIP call notification response as a caller ID feedback mechanism to the calling entity, thereby supporting troubleshooting and detecting CLI issues automatically, efficiently and at scale.

In addition, by assigning a value to a predefined integrity parameter in a call notification message and then tracking a change to the parameter value via a change flag, the call notification message free-riding strategy further tracks caller ID and/or call ID feedback integrity during a call signaling session, and identifies a caller ID or caller ID feedback transmission integrity issue.

Although various embodiments are described with respect to SIP, it is contemplated that the approach described herein may be used with any VoIP signaling protocols, such as H.323, Inter-Asterisk Exchange, Extensible Messaging and Presence Protocol, Real Time Streaming Protocol, and the like.

A technical benefit of the call notification message free-riding strategy provided herein is to transmit a caller ID presented on a callee device in a call notification message during a call signaling session back to the caller side for processing, without using extra channels like the existing strategies. A predefined caller identification parameter is shared among the entities (e.g., via SIP) to label the caller ID presented on a callee device in a call notification message. Since there are many components in a header, such label is required to mark this piece of data. With such label, the entities know where to get the presented caller ID from a SIP response for processing, such as comparing against the actual caller ID to check for spoofing. Therefore, the spoofing detection can be done automatically, effectively, and at scale for all SIP calls.

Another technical benefit of this approach is applying a pre-defined feedback integrity parameter to label other data for tracking any changes to a feedback integrity value, as an insurance of the integrality of the presented caller ID during its transmission to the caller side. Yet another technical benefit of this approach is applying a pre-defined caller ID integrity parameter to label other data for tracking any changes to a caller ID integrity value, as an insurance of the integrality of the caller ID during its transmission to the callee side.

Another technical benefit of this approach is real-time or substantially real-time tracking of caller ID mismatches, caller ID feedback transmission integrality, and caller ID transmission integrality, rather than waiting for user reports of such instances. This saves time and provides a more complete picture of systematic issues.

Another technical benefit of this approach is the ability to log and analyze caller ID mismatch instances, caller ID feedback transmission integrality issues, and caller ID transmission integrality issues, and develop counter measurements. These and other technical benefits of the techniques disclosed herein will be evident from the discussion of the example implementations that follow.

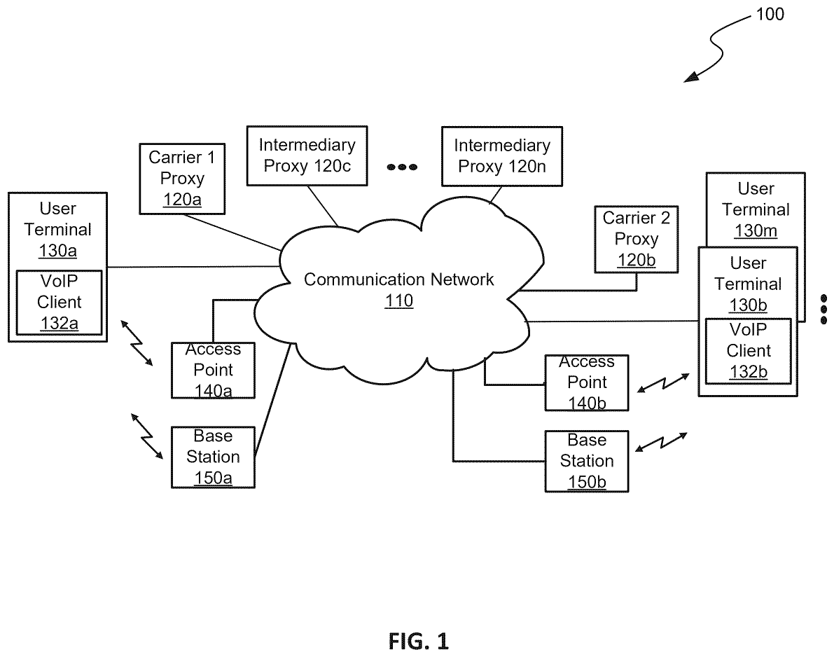

FIG. 1 is a block diagram illustrating an example of a communication services system 100. The communication services system 100 may include a communication network 110 (e.g., including internet), proxies 120a-120n (collectively referred to as proxies 120, e.g., carrier proxies 120a, 120b, intermediary proxies 120c-120n, etc.), user terminals 130a-130m (also collectively referred to as UTs or UT 130, e.g., desktops, laptops, smart phones, etc.), access points 140, and base stations 150 which, in some examples, all connect to the communication network 110. The communication services system 100 may include more or less devices than illustrated in FIG. 1, which is shown by way of example only.

By way of example, the communication network 110 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof. The network may be a combination of one or more public and/or private networks and may be implemented at least in part by the Internet.

The proxy 120a-n are call operator proxies or intermediary proxies each of which serves as an intermediary in VoIP communications, managing signaling and facilitating call setup, routing, and teardown between endpoints. Modern call operator proxies are predominantly software-based and operate on standard server hardware. The hardware requirements of a proxy 120 depend on factors like call volume, concurrent sessions, and desired performance. The software aspect of the proxy 120 encompasses the operating system, proxy server software, and additional tools for management and security. The proxy server software manages call signaling, call routing, and related functions. The proxy 120 includes web-based interfaces or command-line tools facilitating configuration, monitoring, and maintenance of the proxy 120. In addition, the proxy 120 includes firewalls, intrusion detection systems, and encryption protocols that protect the proxy 120 from unauthorized access and ensure secure communications.

The UT 130a-m is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UT 130 can support any type of interface to the user (such as “wearable” circuitry, etc.). While the example implementation illustrated in FIG. 1 includes a plurality of UTs 130, other implementations may include a different number of UTs that utilize services provided by the communication services system 100.

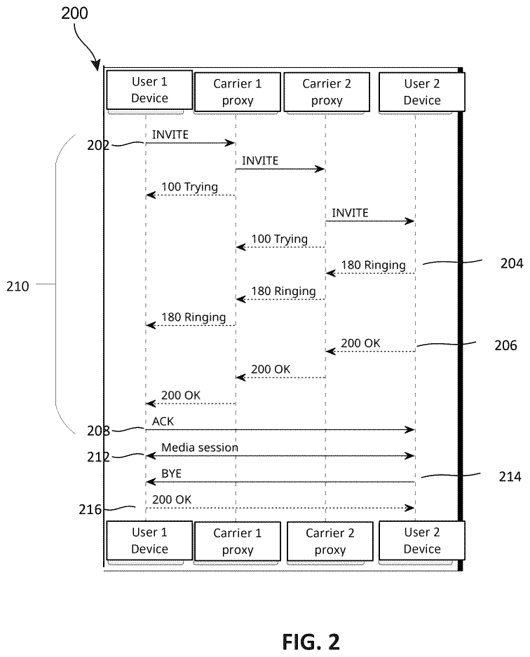

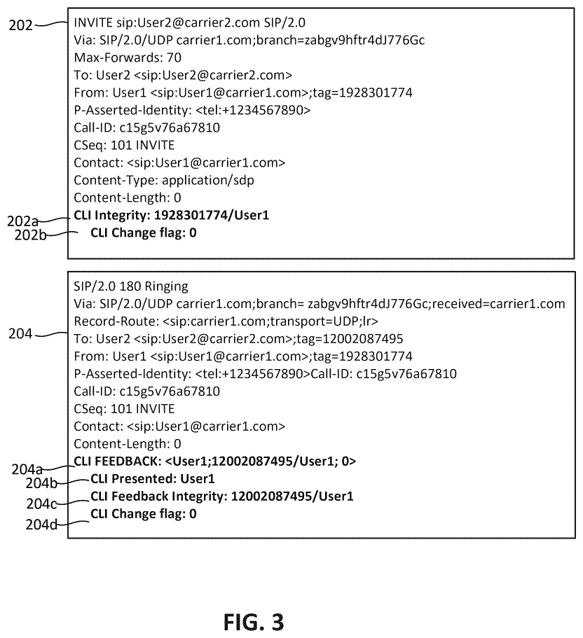

Preferably, the UTs 130a-m include VoIP clients 132a-m. Each of the VoIP client 132a-m is a web-enabled native application, which enables users to provide caller ID feedback via a call signaling session. The web-enabled native application utilizes services provided by the communication services system 100 including but not limited to providing caller ID feedback via a call signaling session. The native application implements the call notification message free-riding strategy of the system as shown in FIGS. 2-3. In other implementations, the VoIP client 132b is used for tracking caller ID and/or call ID feedback integrity provided by the communication services system 100.

The access points 140a-b are wireless access points (APs), each of which primarily consists of hardware components like antennas, radio transceivers, a CPU, and a network interface. The software component of an access point manages the wireless communication protocols, security settings, and user authentication, allowing the access point to connect to a wired network wirelessly (essentially acting as a bridge between wired and wireless networks).

The base stations 150a-b are communication network base stations each of which typically consists of hardware components like transceivers (TRX), antennas, power amplifiers, duplexers, and a baseband processor. The software of a base station 150 supports the base station controller (BSC) functionality which manages signal processing, handoff operations, and communication with a core network, all working together to transmit and receive radio signals to mobile devices within a cellular network area.

By way of example, the proxies 120, the UTs 130, the access points 140, and the base stations 150 communicate with each other and other components of the communication network 110 using well known, new or still developing protocols. In this context, a protocol includes a set of rules defining how the network nodes within the communication network 110 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

FIG. 2 is a sequence diagram of a Voice over Internet Protocol (VoIP) signaling session of the system of FIG. 1. Taking SIP as an example, the signaling session facilitates the establishment, management, and termination of real-time communication between devices. In a scenario involving User 1's device (e.g., UT 130a), Carrier 1's proxy (e.g., Carrier 1 Proxy 120a), Carrier 2's proxy (e.g., Carrier 2 Proxy 120b), and User 2's device (e.g., UT 130b), the SIP signaling process unfolds through a series of steps.

User 1's device, acting as a SIP User Agent Client (UAC), initiates the session by sending an Invite 202 to Carrier 1's proxy. This Invite 202 includes details such as User 1's identity, User 2's intended address, session parameters, and supported media formats.

Upon receiving the Invite 202, Carrier 1's proxy examines the Invite 202 to determine the appropriate routing path toward User 2's device. This may involve consulting a location service or forwarding the Invite 202 to another proxy. Carrier 1's proxy then forwards the Invite 202 to Carrier 2's proxy, by adding its own information to the SIP headers to maintain the signaling path. Carrier 2's proxy server receives the Invite 202 from Carrier 1's proxy. It processes the Invite 202 similarly, determining the best route to User 2's device. After updating the SIP headers with its own information, Carrier 2's proxy forwards the Invite 202 to User 2's device.

Carrier 1's and Carrier 2's proxy servers primarily handle the routing of SIP messages, ensuring they reach the correct destination. They may also enforce policies, provide security functions, and assist in user location services. Each proxy server updates specific SIP headers, such as the Via header, to record the path of the request. This facilitates proper routing of responses and helps in diagnosing signaling issues.

User 2's device, acting as a SIP User Agent Server (UAS), alerts the user 2 of the incoming call and sends a 180 ringing response 204 back through the proxy servers to User 1's device. This 180 ringing response 204 traverses Carrier 2's proxy and Carrier 1's proxy, each updating the SIP headers to reflect the signaling path. When User 2 accepts the call, User 2 device sends a 200 OK response 206, indicating readiness to establish the session. This message 205 includes the agreed-upon session parameters and supported media formats. The 200 OK response 206 follows the reverse path through Carrier 2's and Carrier 1's proxies back to User 1's device. Upon receiving the 200 OK response 206, User 1's device sends an ACK request 208 directly to User 2's device, confirming the session parameters. This completes the three-way handshake, and a call signaling session 210 is established, allowing direct communication between User 1 and User 2.

After the signaling process, a media session 212 (e.g., audio or video) is typically established directly between User 1's and User 2's devices, bypassing the proxy servers. This direct media path reduces latency and preserves bandwidth. The Invite 202 and the 200 OK response 206 contain Session Description Protocol (SDP) information, which is used to negotiate media parameters like codec selection and transport addresses.

When either User 1 or User 2 decides to end the call, their device sends a BYE request 214 to the other party. If User 2 initiates the termination, the BYE request 214 is sent directly to User 1's device, which responds with a 200 OK 216, confirming the termination. This exchange effectively ends the session. This SIP signaling flow thus ensures efficient and reliable communication sessions across different networks and devices.

As used herein, the term “call notification message” refers to (1) an initial call notification (e.g., Invite 202 in FIGS, 2-3) originated from the caller device, or (2) a call notification response containing the caller ID, such as 180 (Ringing) or 183 (Session Progress) response.

As described, the call notification message free-riding strategy inserts new parameters (e.g., a caller ID as presented on a callee device) and their values into a call notification message during a call signaling session, such as a SIP session, to detect a mismatch between a caller ID associated with User 1 device and a caller ID presented on User 2 device during the call signaling session. As such, no extra hardware and software resources are required outside of SIP, and the presented caller ID is sent back to User 1 device or Carrier 1 proxy via a SIP call notification response (without using a separated channel). FIG. 3 are example call notification messages during a VoIP signaling session that implement the techniques described herein.

In one implementation, the call notification message free-riding strategy alters a header of a call notification response (e.g., 180 ringing response 204 in FIG. 1), by adding a new component: a header field, such as a CLI Presented header field 204b in FIG. 3, or a new parameter in an existing header field, and inserting therein a caller ID (e.g., User 1) displayed on a callee's device (e.g., USER2 phone) as the header field value. For example, the CLI Presented header field value (i.e., the assumed caller identifier as presented on a callee device) is extracted from the From header field (e.g., USER1 in Invite 202 in FIG. 3) or the P-Asserted-Identity (PAI) header field (e.g., +1234567890 in Invite 202 in FIG. 3) of the Invite 202. Since the PAI header field indicates the verified caller ID, as asserted by a trusted intermediary in the call flow, the value in the PAI header field is preferred over the caller ID in the From field to be used as the CLI Presented header field value, since the caller ID in the From field can be manipulated by the caller.

In other implementations, the caller ID presented value is carried via a new header field parameter, since SIP allows for a wide range of custom headers beyond the standard set. To distinguish from a generic notification message including the caller ID, the present application excludes the payload portion of the call notification message from inserting the caller ID presented value. Although SIP does not have a designated trailer section, some other protocols may use a trailer for checksum verification or other purposes, and such trailer can carry the caller ID presented value as the CLI Presented header field.

The caller ID presented value can be extracted by a client at the callee's device (e.g., USER2 phone), or by a callee carrier proxy (e.g., the final SIP entity) when generating the 180 Ringing response on behalf of the callee device. Thereafter, a client application at the caller's device (e.g., USER1 phone) receives the call notification response then verifies whether the caller ID displayed on the callee's device is the same as the actual caller ID. Alternatively, a caller operator proxy (e.g., carrier 1 proxy) may verify the caller ID on behalf of the caller device.

As such, besides a designated SIP notification function (e.g., 180 (Ringing) or 183 (Session Progress)), the call notification response serves an additional function of caller ID verification using minimal load (e.g., adding a new header field/parameter). This strategy is simpler, efficient, and cost effective for verifying the caller ID presented on a callee device.

CLI Feedback processing can be handled by the phone service provider (e.g., MS, Skype, etc.), or relayed to other phone service providers on the call path, to identify the cause of a discrepancy between the displayed caller ID and the actual caller ID, by checking if the issue lies with the caller's information not being updated with their phone service provider, if the receiving phone is incorrectly interpreting the caller ID data, or if there's a potential case of caller ID spoofing, and contact the phone service provider to investigate further. Example causes include incorrect caller ID display (wrong name or number), delayed updates to caller ID information, caller ID spoofing, and problems with network transmission errors that prevent accurate caller ID delivery; outdated information in the carrier's database, incorrect settings on the user's phone, the caller not having properly set up their caller ID details with their provider, and the like.

One example cause is an international phone operator changing the caller ID of a domestic phone number into an international phone number to get a cheaper calling rate overseas. Another example cause is a third party intercepting and replacing a caller ID with an advertisement (e.g., “Buy Bitcoin”) to display on the callee device. A third example cause is a caller/spoofer inserts a spoofed caller ID (e.g., “IRS”) in the Invite 202 that is presented on the callee device. A fourth example cause is legitimate spoofing, such as *67, or when a doctor calls a patient from her personal mobile phone and displays the office number rather than the personal phone number or a business displays its toll-free call-back number.

In another implementation, the call notification message free-riding strategy further alters the header of the call notification response (e.g., 180 ringing response 204 in FIG. 1), by adding new components a CLI Feedback Integrity header field 204c and a change flag 204d in FIG. 3, or a new parameter in an existing header field, and inserting therein a CLI Feedback Integrity value and a change flag value. At the bottom of the Invite 202 in FIG. 3, a CLI Feedback header field 204a is added to lead the header fields 204b-204d. The value of the header field 204a is a combination of the values of the header fields 204b-204d.

The CLI Presented header field 204b is automatically set by the final SIP entity with a value of a caller ID (e.g., User 1 or a spoofed ID) displayed on a callee's device (e.g., User 2 device). The value is transmitted via a SIP response, and later checked by a calling entity (e.g., User 1 device or Carrier 1 proxy) against the actual caller ID to determine whether there is a mismatch.

The value of the CLI feedback Integrity header field 204c is automatically set by the final SIP entity, and updated by an intermediary proxy whenever any of the input fields'values of the header field 204c is changed. The header field 204c ensures the integrity of the CLI Presented field value by detecting any changes made by entities along the SIP call path. The value of this field is a combination of a “To” tag field value (e.g., 12002087495) and the CLI Presented field value (e.g., User1), producing a unique value (e.g., “12002087495/User1” in FIG. 3) for the call and including a change flag (e.g., CLI Change flag=0 204d in FIG. 3). The CLI feedback integrity value is encrypted for security. The CLI Feedback Integrity field is automatically generated by concatenating the To tag and the CLI Presented field value, and then encrypted. The CLI Presented field value is set by the final SIP entity and must not be changed by any SIP entity along the call path.

The To tag value is included to make the encryption more effective. The To tag value can be generated by a callee carrier proxy or a client on the callee device using various mechanisms. For example, the callee carrier proxy may use a random or unique value to generate a To tag value to ensure no collision with other requests from the same user. The tag value can be a random alphanumeric string or a specific value derived from the transaction. As another example, the client on the callee device can create a To tag value based on some logic, such as the time the request was made, a transaction ID, or a random number.

The CLI Change flag monitors the CLI Presented field value and does not care about the FROM header field. Its goal is to ensure that the presented CLI reported by the final SIP entity is what was received by the calling SIP entity, by flagging any changes along the way. Since the CLI Presented and CLI Feedback Integrity field value must remain unchanged after being set at the final SIP entity, it is expected that the CLI Change flag would also not change. However, with potential bad actors, it is necessary to check if the CLI feedback information that has been sent is intact or a change has occurred.

The CLI Change Flag value is automatically set to 0 in the 180/183 SIP response by the SIP final entity then transmitted onward. The Flag value can only be 0 or 1. If the CLI Change Flag value is 1, no further checks are needed by the current proxy, since a change has already been made and detected. If the CLI Change Flag value is 0, no changes made to the CLI Feedback. If so, the proxy automatically checks for a change in the CLI Presented value and update the CLI Change Flag value to 1, if a change has occurred. The CLI Change Flag can be legitimately and automatically updated by any SIP proxy as the call traverses the path. A change is detected by comparing the caller ID value in the CLI Presented header field 204b with the caller ID value in the decrypted CLI Feedback Integrity value.

When detecting such change, the SIP proxy alerts the caller entity (e.g., User1 and/or carrier 1) of the problem, as well as logs the problem for a phone network operator (e.g., Verizon) to investigate the cause(s) of the problem. An example cause is a spoofer switches the presented/spoofed caller ID back (e.g., IRS) to the original caller ID (e.g., User1) in the SIP response, to disguise the spoofing. For another example, an international phone operator changes the international phone number back to the caller ID of the domestic phone number after making a cheaper call overseas.

In another implementation, the strategy uses the CLI Feedback header field 204a in place of the CLI Feedback Integrity field 204c for tracking the integrity of the transmission of the CLI Presented value (e.g., User 1 or a spoofed value) back to the calling entities. The encryption of the value of the header field 204a provides even stronger protection, since it is a combination of more values of the header fields 240b-204d. The processing of this implementation is similar to the processing of the CLI Feedback Integrity field 204c as discussed.

In yet another implementation, the call notification message free-riding strategy also alters the header of the call notification (e.g., Invite 202 in FIG. 1), by adding another new header field, such as an CLI Integrity header field (e.g., CLI Integrity header field 202a in FIG. 3). The value of the CLI Integrity header field is automatically set by the initial SIP entity (e.g., Carrier 1 proxy), and updated by an intermediary proxy whenever any of the input fields'values changed. The CLI integrity value can be encrypted for security. This CLI Integrity header field 202a ensures the integrity of the CLI value by detecting any changes made by entities along the SIP call path. The value of this CLI field is a combination of a “From” tag field value (e.g., 1928301774) and the caller ID (e.g., User 1) in the From header field, i.e., a unique value (e.g., “1928301774/User1” in FIG. 3). The CLI integrity value is encrypted for security. The CLI Integrity field is automatically generated by concatenating the From tag and the caller ID, and then encrypted. The CLI integrity value is set by the Carrier 1 proxy and must not be changed by any SIP entity along the call path.

The From tag value is included to make the encryption more effective. The From tag value can be generated by a caller carrier proxy or a client on the caller device using various mechanisms. For example, the caller carrier proxy may use a random or unique value to generate a From tag value to ensure no collision with other requests from the same user. The tag value can be a random alphanumeric string or a specific value derived from the transaction. As another example, the client on the caller device can create a From tag value based on some logic, such as the time the request was made, a transaction ID, or a random number.

The call notification message free-riding strategy also adds a CLI change flag 202b (e.g., CLI Change flag 202b in FIG. 3). The CLI Change flag 202b monitors the caller ID value in the FROM header field, to ensure that the caller ID is what was received by the callee SIP entity, by flagging any changes along the way. With potential bad actors, it is necessary to check if the caller ID that has been sent is intact or a change has occurred.

The CLI Change flag value is automatically set to 0 in the Invite 202 by the SIP calling entity then transmitted onward. The Flag value can only be 0 or 1. If the CLI Change Flag value is 1, no further checks are needed by the current proxy, since a change to the caller ID has already been made and detected. If the CLI Change Flag value is 0, no changes made to the caller ID. If so, the proxy automatically checks for a change in the caller ID and update the CLI Change flag value to 1, if a change has occurred. The CLI Change flag 202b can be legitimately and automatically updated by any SIP proxy as the call traverses the path. A change is detected by comparing the caller ID value in the From header field with the caller ID value in the decrypted CLI Integrity header value.

The SIP entity/proxy alerts the calling entities (e.g., User 1 device and/or Carrier 1 proxy) the problem, and/or drops the call signaling session. One example scenario is Carrier 2 detects a spoofed caller ID (e.g., “FBI”) presented on the callee device inserted in the CLI header field as different from the caller's real ID (e.g., spoofer) in the From header field, then real-time intervenes illegitimate spoofing and/or report the spoofer.

In other implementations, the Integrity functions can be implemented via adding a new header field parameter to an existing SIP header field. In yet other implementations, both the CLI Feedback function and the CLI Feedback Integrity function are added as new parameters to the same existing SIP header field.

The system can ensure the new header/parameter can only be set by the final SIP entity (e.g., the callee carrier) and cannot be modified by any intermediary systems (to ensure integrity): by configuring the authentication mechanism (e.g., username/password, certificates) in the STIR/SHAKEN verification framework to authenticate the final SIP entity.

The system can provide additional protection for the new call notification message components (e.g., CLI feedback, CLI feedback integrity, CLI integrity): Encrypt the components with shared keys.

When there is no caller ID in the From or PAI header field, the system can send a 606 Not Acceptable response to the caller device, then drop the call. When the callee's carrier or the callee device doesn't support the parameter scheme, the system can send a 606 Not Acceptable response to the caller device, then drop the call.

The call notification message free-riding strategy is applicable to both Public Switched Telephone Network (PSTN) calls (e.g., Verizon) and virtual calls (e.g., Google Voice, Cisco, or video conferencing platforms like Zoom or Skype, where a caller has a fixed account address associated with the VoIP service (not necessary a virtual phone number). Beside SIP, the call notification message free-riding strategy is applicable to H.323, Inter-Asterisk Exchange (IAX) which is a SIP alternative, XMPP (Extensible Messaging and Presence Protocol), and RTSP (Real Time Streaming Protocol), and the like.

The system may register the new header fields/parameters with the IETF to make them standard SIP header fields, or just share as proprietary header fields with selected partners. To add a new header field or parameter to the SIP protocol, the system will follow the established process of registering the new header fields with the IETF (Internet Engineering Task Force) by submitting a proposed standard through the appropriate channels, ensuring it adheres to the guidelines outlined in RFC 3968. To share as proprietary header fields with selected partners, most SIP libraries provide a method like “setHeader” where a user can specify the header name and its corresponding value to add the custom header to the message. However, other carriers will not know how to handle our custom header fields correctly.

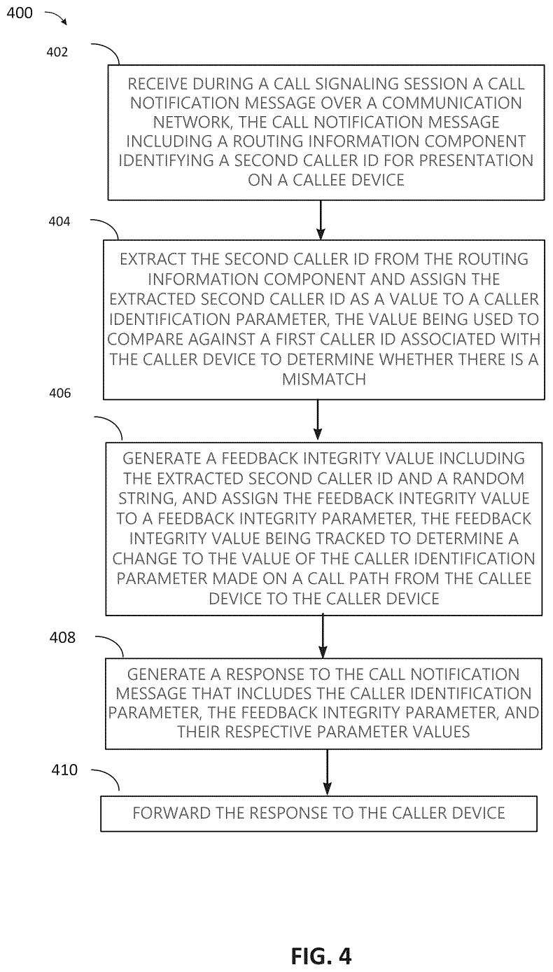

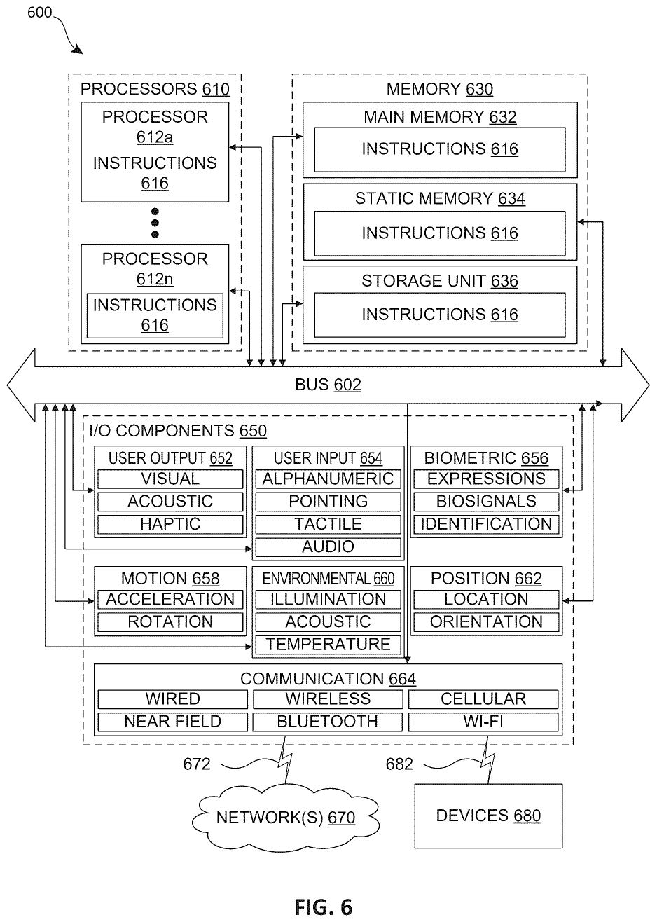

FIG. 4 is a flow chart of an example process for providing caller ID feedback via a call signaling session according to the techniques disclosed herein. The process 400 can be implemented by the communication services system 100 or its components shown in the preceding examples. The process 400 may be implemented in, for instance, the example machine including a processor and a memory as shown in FIG. 6. As such, the communication services system 100 can provide means for accomplishing various parts of the process 400, as well as means for accomplishing embodiments of other processes described herein in conjunction with other components of the communication services system 100. Although the process 400 is illustrated and described as a sequence of steps, it is contemplated that various embodiments of the process 400 may be performed in any order or combination and need not include all the illustrated steps.

In one implementation, the data processing system 100 detects a mismatch between a first caller identification (“ID”, e.g., the actual ID of User 1) associated with a caller device (e.g., User 1 device in FIG. 2) and a second caller ID (e.g., the ID of User 1 as presented on the user 2 device) for presentation on a callee device (e.g., User 2 device in FIG. 2) during a call signaling session (e.g., the call signaling session 210 in FIG. 2) for a call including the caller device and the callee device. For example, in step 402, a processor (e.g., residing on User 2 device or Carrier 2 proxy) receives during the call signaling session a call notification message (e.g., the Invite 202 or the 180 ringing response 204 in FIG. 2) over a communication network (e.g., the communication network 110). The processor may be located either in the callee device that supports a voice over internet protocol (VoIP) signaling protocol (e.g., SIP), or in a callee carrier proxy (e.g., Carrier 2 proxy) on the call path. The callee carrier proxy works as a gateway between the communication network and the callee device.

In one implementation, the call notification message is a call notification request (e.g., the Invite 202) for the call sent from the caller device to the callee device, or a call notification response (e.g., the ringing response 204) to the call notification request sent from the callee device to the caller device following the voice over internet protocol (VoIP) signaling protocol. The call notification message notifies the callee device about an incoming call from the caller device or notifies the caller device of a response of the callee device to the incoming call. The call notification message includes a routing information component (e.g., a header) identifying the second caller ID for presentation on the callee device (e.g., the ID of User 1 as presented on the user 2 device) and a callee ID associated with the callee device. Besides SIP, the VoIP signaling protocol can be H.323, Inter-Asterisk Exchange, Extensible Messaging and Presence Protocol, or Real Time Streaming Protocol.

In step 404, the processor extracts the second caller ID from the routing information component (e.g., the header) and assigning the extracted second caller ID as a value (e.g., User 1, or a spoofed caller ID) to a caller identification parameter (e.g., the CLI Presented header field 204b in FIG. 3), the value (e.g., User 1, or a spoofed caller ID) being used to compare against the first caller ID associated with the caller device (e.g., User 1) to determine whether there is the mismatch. For example, the second caller ID is extracted from a message originator field (e.g., the From header field with a value of USER1 in Invite 202 in FIG. 3) or a verified message originator field (e.g., the P-Asserted-Identity (PAI) header field with a value of +1234567890 in Invite 202 in FIG. 3) of the routing information component of the call notification message.

In step 406, the processor generates a feedback integrity value (e.g., 12002087495/User1 in FIG. 3) including the extracted second caller ID (e.g., User 1) and a random string (e.g., 12002087495), and assigns the feedback integrity value to a feedback integrity parameter (e.g., the CLI Feedback Integrity header field 204c in FIG. 3), the feedback integrity value being tracked to determine a change to the value of the caller identification parameter (e.g., the CLI Presented header field 204b in FIG. 3) made on a call path from the callee device to the caller device.

In step 408, the processor generates a response (e.g., the ringing response 204) to the call notification message (e.g., the Invite 202) that includes the caller identification parameter, the feedback integrity parameter, and their respective parameter values. In step 410, the processor forwards the response to the caller device (e.g., User 1 device). The processor forwards the response to a caller carrier proxy (e.g., Carrier 1 proxy) on the call path, and the caller carrier proxy works as a gateway between the communication network and the caller device. The caller carrier proxy compares the second caller ID (e.g., User 1, or a spoofed caller ID) in the response against the first caller ID (e.g., User 1) associated with the caller device to determine whether there is the mismatch. Upon determining the mismatch, the caller carrier proxy logs the mismatch in to a caller ID issue log, and sends at least one of an alert of the mismatch to the caller device, or a notification to a communication service provider (e.g., a VoIP server provider such as via Microsoft Teams, Skype, and the like, or a communication network operator such as Verizon) on the call path to identify a cause of the mismatch, while the notification includes the mismatch or the caller ID issue log.

In another implementation, the processor further generates a change flag value (e.g., initially as ‘0 ’ then possibly as ‘1’ if spoofed) based on a change to the feedback integrity value (e.g., 12002087495/User1 in FIG. 3) and assigning the change flag value to a change flag (e.g., the change flag 204d in FIG. 3), and the response (e.g., the ringing response 204) further includes the change flag and the change flag value. The processor works independently or together with the other processors of the proxies on the call path to identify the change to the feedback integrity value, and to identify a cause of the change to the feedback integrity value. The random string is a value of a message recipient field tag (e.g., a To tag) of the call notification message.

In one implementation, the processor of the caller carrier proxy encrypts the feedback integrity value and assigns the encrypted feedback integrity value to the feedback integrity parameter. Upon receiving the response (e.g., the ringing response 204), the processor of the proxy on the call path determines whether the change flag value meets a threshold (e.g., 1). When determining that the change flag value meets the threshold, the processor of the proxy passes the call notification message to a subsequent proxy on the call path, since there is already a change to the feedback integrity value. When determining that the change flag value is below the threshold, the processor of the proxy decrypts the encrypted feedback integrity value back to the feedback integrity value, and compares the extracted second caller ID (e.g., User 1) in the feedback integrity value with the extracted second caller ID (e.g., User 1 or a domestic phone number if changed) in caller identification parameter, to determine whether there is a match. The processor of the proxy leaves the caller ID change flag value as is when there is a match (i.e., no spoofing), or updates the caller ID change flag value to the threshold (e.g., 1) when there is a mismatch (e.g., changed into the domestic phone number).

In another implementation, the processor of a caller carrier proxy (e.g., Carrier 1 proxy) extracts a third caller ID (e.g., User 1) from a message originator field (e.g., the From header filed) of the routing information component (e.g., the header) of the call notification message (e.g., the Invite 202). The processor generates a caller ID integrity value by encrypting a concatenation of the extracted third caller ID (e.g., User 1) and another random string (e.g., 1928301774), and assigning the caller ID integrity value to a caller ID integrity parameter (e.g., the CLI Integrity header field 202a in FIG. 3), the caller ID integrity value being tracked to determine a change to the third caller ID made on a call path from the caller device (e.g., User 1 device) to the callee device (e.g., User 2 device). The other random string is extracted from a message originator field tag (e.g., the From tag) of the call notification message (e.g., the Invite 202). The processor assigns a caller ID change flag value (e.g., an encrypted value of 1928301774/User1) to a caller ID change flag (e.g., the CLI change flag 202b in FIG. 3) as below a threshold (e.g., ‘1’), and the call notification message includes the caller ID integrity parameter, the caller ID change flag, and their respective values.

Upon receiving the call notification message (e.g., the Invite 202), the processor of the other proxy on the call path determines whether the caller ID change flag value meets a threshold (e.g., 1). When determining that the caller ID change flag value meets the threshold, the processor passes the call notification message to a subsequent proxy on the call path. When determining that the caller ID change flag value is below the threshold, the processor decrypts the caller ID integrity value to extract the extracted third caller ID (e.g., User 1), and compares the extracted third caller ID (e.g., User 1) from the caller ID integrity value with the third caller ID (e.g., User 1 or ‘FBI’ if spoofed) in the message originator field, to determine whether there is a match. The processor leaves the caller ID change flag value as is, when there is a match, or updates the caller ID change flag value to the threshold (e.g., ‘1’), when there is a mismatch.

The detailed examples of systems, devices, and techniques described in connection with FIGS. 1-4 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-4 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

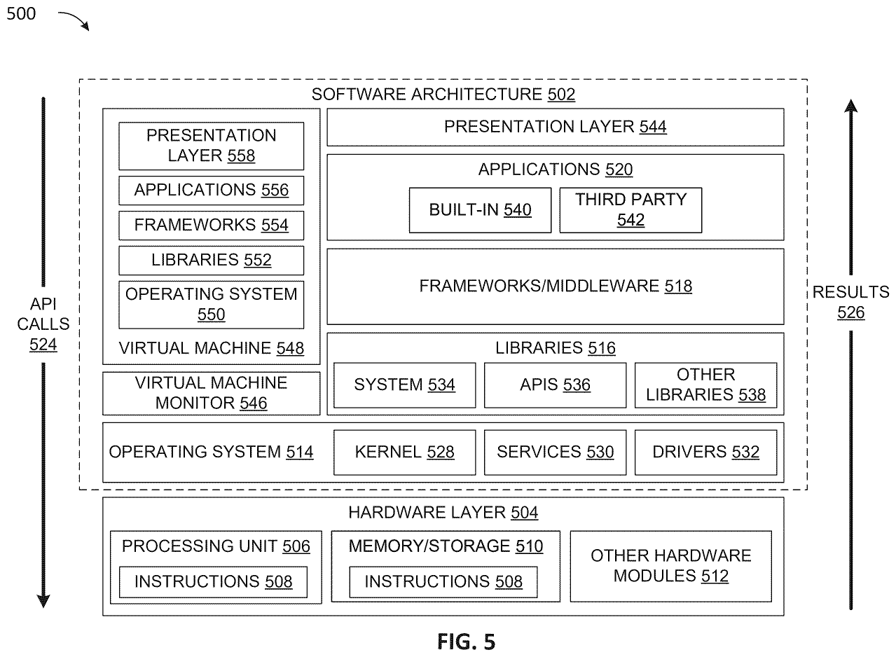

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as a machine 600 of FIG. 6 that includes, among other things, processors 610, memory 630, and input/output (I/O) components 650. A representative hardware layer 504 is illustrated and can represent, for example, the machine 600 of FIG. 6. The representative hardware layer 504 includes a processing unit 506 and associated executable instructions 508. The executable instructions 508 represent executable instructions of the software architecture 502, including implementation of the methods, modules and so forth described herein. The hardware layer 504 also includes a memory/storage 510, which also includes the executable instructions 508 and accompanying data. The hardware layer 504 may also include other hardware modules 512. The executable instructions 508 held by processing unit 506 may be portions of the executable instructions 508 held by the memory/storage 510.

The example software architecture 502 may be conceptualized as layers, each providing various functionality. For example, the software architecture 502 may include layers and components such as an operating system (OS) 514, libraries 516, frameworks/middleware 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks/middleware 518 (also sometimes referred to as middleware) provide a higher-level common infrastructure that may be used by the applications 520 and/or other software modules. For example, the frameworks/middleware 518 may provide various graphic user interface (GUI) functions, high-level resource management, or high-level location services. The frameworks/middleware 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular platform. The applications 520 may use functions available via OS 514, libraries 516, frameworks/middleware 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement modules or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a neural processing unit (NPU), a tensor processing unit (TPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660, and/or position components 662, among a wide array of other physical sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 658 may include, for example, acceleration sensors (for example, an accelerometer) and rotation sensors (for example, a gyroscope). The environmental components 660 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 662 may include, for example, location sensors (for example, a Global Position System (GPS) receiver), altitude sensors (for example, an air pressure sensor from which altitude may be derived), and/or orientation sensors (for example, magnetometers).

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 664, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various implementations have been described, the description is intended to be exemplary, rather than limiting, and it is understood that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system for detecting a mismatch between a first caller identification (“ID”) associated with a caller device and a second caller ID for presentation on a callee device during a call signaling session for a call including the caller device and the callee device, the data processing system comprising:
a processor; and
a machine-readable storage medium storing executable instructions that, when executed, cause the processor alone or in combination with other processors to perform operations of:
receiving during the call signaling session a call notification message over a communication network, the call notification message notifying the callee device about an incoming call from the caller device or notifying the caller device of a response of the callee device to the incoming call, the call notification message including a routing information component identifying the second caller ID for presentation on the callee device and a callee ID associated with the callee device;
extracting the second caller ID from the routing information component and assigning the extracted second caller ID as a value to a caller identification parameter, the value being used to compare against the first caller ID associated with the caller device to determine whether there is the mismatch;
generating a feedback integrity value including the extracted second caller ID and a random string and assigning the feedback integrity value to a feedback integrity parameter, the feedback integrity value being tracked to determine a change to the value of the caller identification parameter made on a call path from the callee device to the caller device;
generating a response to the call notification message that includes the caller identification parameter, the feedback integrity parameter, and their respective parameter values; and
forwarding the response to the caller device.

2. The data processing system of claim 1, wherein the call notification message is a call notification request for the call sent from the caller device to the callee device or a call notification response to the call notification request sent from the callee device to the caller device following a voice over internet protocol (VoIP) signaling protocol.

3. The data processing system of claim 1, wherein the machine-readable storage medium further stores executable instructions that, when executed, cause the processor alone or in combination with other processors to perform operations of extracting the second caller ID from a message originator field or a verified message originator field of the routing information component of the call notification message.

4. The data processing system of claim 1, wherein the processor is located either in the callee device that supports a voice over internet protocol (VoIP) signaling protocol, or in a callee carrier proxy on the call path, wherein the callee carrier proxy works as a gateway between the communication network and the callee device.

5. The data processing system of claim 1, wherein the machine-readable storage medium further includes instructions configured to cause the processor alone or in combination with other processors to perform:
forwarding the response to a caller carrier proxy on the call path, wherein the caller carrier proxy works as a gateway between the communication network and the caller device;
comparing the second caller ID in the response against the first caller ID associated with the caller device to determine whether there is the mismatch;
upon determining the mismatch, logging the mismatch in to a caller ID issue log; and
sending at least one of an alert of the mismatch to the caller device, or a notification to a communication service provider on the call path to identify a cause of the mismatch, wherein the notification includes the mismatch or the caller ID issue log.

6. The data processing system of claim 1, wherein the machine-readable storage medium further includes instructions configured to cause the processor alone or in combination with other processors to perform:
generating a change flag value based on a change to the feedback integrity value and assigning the change flag value to a change flag, wherein the response further includes the change flag and the change flag value;
identifying the change to the feedback integrity value; and
identifying a cause of the change to the feedback integrity value.

7. The data processing system of claim 6, wherein the random string is a value of a message recipient field tag of the call notification message, and the machine-readable storage medium further includes instructions configured to cause the other processors in proxies on the call path to perform:
encrypting the feedback integrity value and assigning the encrypted feedback integrity value to the feedback integrity parameter.

8. The data processing system of claim 7, wherein the machine-readable storage medium further includes instructions configured to cause the processor alone or in combination with the other processors to perform:
upon receiving the response, determining whether the change flag value meets a threshold;
when determining that the change flag value meets the threshold, passing the call notification message to a subsequent proxy on the call path;
when determining that the change flag value is below the threshold, decrypting the encrypted feedback integrity value back to the feedback integrity value, and comparing the extracted second caller ID in the feedback integrity value with the extracted second caller ID in caller identification parameter, to determine whether there is a match; and
leaving the caller ID change flag value as is when there is a match, or updating the caller ID change flag value to the threshold when there is a mismatch.

9. The data processing system of claim 1, wherein the machine-readable storage medium further includes instructions configured to cause the other processors in a caller carrier proxy on the call path to perform:
extracting a third caller ID from a message originator field of the routing information component of the call notification message;
generating a caller ID integrity value by encrypting a concatenation of the extracted third caller ID and another random string, and assigning the caller ID integrity value to a caller ID integrity parameter, the caller ID integrity value being tracked to determine a change to the third caller ID made on a call path from the caller device to the callee device, wherein the other random string is extracted from a message originator field tag of the call notification message; and
assigning a caller ID change flag value to a caller ID change flag as below a threshold, wherein the call notification message includes the caller ID integrity parameter, the caller ID change flag, and their respective values.

10. The data processing system of claim 9, wherein the machine-readable storage medium further includes instructions configured to cause the other processors in proxies on the call path to perform:
upon receiving the call notification message, determining whether the caller ID change flag value meets a threshold;
when determining that the caller ID change flag value meets the threshold, passing the call notification message to a subsequent proxy on the call path;
when determining that the caller ID change flag value is below the threshold, decrypting the caller ID integrity value to extract the extracted third caller ID, and comparing the extracted third caller ID from the caller ID integrity value with the third caller ID in the message originator field, to determine whether there is a match; and
leaving the caller ID change flag value as is when there is a match, or updating the caller ID change flag value to the threshold when there is a mismatch.

11. A method for detecting a mismatch between a first caller identification (“ID”) associated with a caller device and a second caller ID for presentation on a callee device during a call signaling session for a call including the caller device and the callee device, the method comprising:
receiving during the call signaling session a call notification message over a communication network, the call notification message notifying the callee device about an incoming call from the caller device or notifying the caller device of a response of the callee device to the incoming call, the call notification message including a routing information component identifying the second caller ID for presentation on the callee device and a callee ID associated with the callee device;
extracting the second caller ID from the routing information component and assigning the extracted second caller ID as a value to a caller identification parameter, the value being used to compare against the first caller ID associated with the caller device to determine whether there is the mismatch;
generating a feedback integrity value including the extracted second caller ID and a random string and assigning the feedback integrity value to a feedback integrity parameter, the feedback integrity value being tracked to determine a change to the value of the caller identification parameter made on a call path from the callee device to the caller device;
generating a response to the call notification message that includes the caller identification parameter, the feedback integrity parameter, and their respective parameter values; and
forwarding the response to the caller device.

12. The method of claim 11, wherein the call notification message is a call notification request for the call sent from the caller device to the callee device or a call notification response to the call notification request sent from the callee device to the caller device following a voice over internet protocol (VoIP) signaling protocol.

13. The method of claim 11, further comprising:
extracting the second caller ID from a message originator field or a verified message originator field of the routing information component of the call notification message.

14. The method of claim 11, wherein the processor is located either in the callee device that supports a voice over internet protocol (VoIP) signaling protocol, or in a callee carrier proxy on the call path, wherein the callee carrier proxy works as a gateway between the communication network and the callee device.

15. The method of claim 11, further comprising:
forwarding the response to a caller carrier proxy on the call path, wherein the caller carrier proxy works as a gateway between the communication network and the caller device;
comparing the second caller ID in the response against the first caller ID associated with the caller device to determine whether there is the mismatch;
upon determining the mismatch, logging the mismatch in to a caller ID issue log; and
sending at least one of an alert of the mismatch to the caller device, or a notification to a communication service provider on the call path to identify a cause of the mismatch, wherein the notification includes the mismatch or the caller ID issue log.

16. A non-transitory computer readable medium for detecting a mismatch between a first caller identification (“ID”) associated with a caller device and a second caller ID for presentation on a callee device during a call signaling session for a call including the caller device and the callee device, the non-transitory computer readable medium storing instructions that, when executed, cause a programmable device to perform functions of:
receiving during the call signaling session a call notification message over a communication network, the call notification message notifying the callee device about an incoming call from the caller device or notifying the caller device of a response of the callee device to the incoming call, the call notification message including a routing information component identifying the second caller ID for presentation on the callee device and a callee ID associated with the callee device;
extracting the second caller ID from the routing information component and assigning the extracted second caller ID as a value to a caller identification parameter, the value being used to compare against the first caller ID associated with the caller device to determine whether there is the mismatch;
generating a feedback integrity value including the extracted second caller ID and a random string and assigning the feedback integrity value to a feedback integrity parameter, the feedback integrity value being tracked to determine a change to the value of the caller identification parameter made on a call path from the callee device to the caller device;
generating a response to the call notification message that includes the caller identification parameter, the feedback integrity parameter, and their respective parameter values; and
forwarding the response to the caller device.

17. The non-transitory computer readable medium of claim 16, wherein the call notification message is a call notification request for the call sent from the caller device to the callee device or a call notification response to the call notification request sent from the callee device to the caller device following a voice over internet protocol (VoIP) signaling protocol.

18. The non-transitory computer readable medium of claim 16, wherein the instructions when executed, further cause the programmable device to perform:
extracting the second caller ID from a message originator field or a verified message originator field of the routing information component of the call notification message.

19. The non-transitory computer readable medium of claim 16, wherein the processor is located either in the callee device that supports a voice over internet protocol (VoIP) signaling protocol, or in a callee carrier proxy on the call path, wherein the callee carrier proxy works as a gateway between the communication network and the callee device.

20. The non-transitory computer readable medium of claim 16, wherein the instructions when executed, further cause the programmable device to perform:
forwarding the response to a caller carrier proxy on the call path, wherein the caller carrier proxy works as a gateway between the communication network and the caller device;
comparing the second caller ID in the response against the first caller ID associated with the caller device to determine whether there is the mismatch;
upon determining the mismatch, logging the mismatch in to a caller ID issue log; and
sending at least one of an alert of the mismatch to the caller device, or a notification to a communication service provider on the call path to identify a cause of the mismatch, wherein the notification includes the mismatch or the caller ID issue log.
